(19) United States
(12) Patent Application Publication
(10) Pub. No.: US 2026/0100618 A1
(43) Pub. Date: Apr. 9, 2026

(54) COIL END COOLING STRUCTURE AND MANUFACTURING METHOD OF A STATOR

(71) Applicant: SUBARU CORPORATION, Tokyo (JP)

(72) Inventor: Kimihiro NAGASE, Tokyo (JP)

(73) Assignee: SUBARU CORPORATION, Tokyo (JP)

(21) Appl. No.: 19/337,368

(22) Filed: Sep. 23, 2025

(30) Foreign Application Priority Data
Oct. 4, 2024 (JP) 2024-174753

(51) Int. Cl. H02K 5/20; B60K 11/02; H02K 5/22; H02K 9/19; H02K 15/148; H02K 15/36

(52) U.S. Cl. CPC H02K 5/203; H02K 5/225; H02K 9/19; H02K 15/148; H02K 15/36; B60K 11/02

(57) ABSTRACT

A coil end cooling structure includes an insulator, and first and second covers. The insulator has first and second protrusions provided on respective end surfaces of a stator core of a stator in the axial direction, and a link to link the protrusions. The first and second covers are secured to the insulator and cover the coil end on the respective end surfaces of the stator. The link is provided along an inner wall of the slot. The first and second covers are provided with a supply port and a discharge port for a coolant that cools a stator coil provided in a slot of the stator core. The supply port is provided on a lower side in a direction of gravity, and the discharge port is provided on an upper side in the direction of gravity.

### CROSS-REFERENCE TO RELATED APPLICATIONS

The present application claims priority from Japanese Patent Application No. 2024-174753 filed on Oct. 4, 2024, the entire contents of which are hereby incorporated by reference.

### BACKGROUND

The disclosure relates to a coil end cooling structure and a manufacturing method of a stator. Motors (rotary electric machines) have been used as power sources for vehicles such as hybrid vehicles and electric vehicles. Such a motor includes a stator and windings mounted on the stator. Japanese Unexamined Patent Application Publication (JP-A) No. 2019-161796 discloses that, to cool the windings of such a motor, a cover is attached to a portion located at an end of a stator core and a coolant is filled inside the cover.

However, in JP-A No. 2019-161796, the coolant enters minute spaces between slots of the stator core and the windings. This prevents the coolant from entering the cover unless supplied at a high discharge pressure, leading to an unintended temperature distribution.

### SUMMARY

An aspect of the disclosure provides a coil end cooling structure configured to cool a stator having a cylindrical stator core and a stator coil provided in a slot of the stator core and having a coil end protruding from an end surface in an axial direction of the stator core. The coil end cooling structure comprises an insulator having a first protrusion provided on one end surface of the stator core in the axial direction, a second protrusion provided on the other end surface, and a link configured to link the first protrusion and the second protrusion. The coil end cooling structure further comprises a first cover secured to the insulator and configured to cover the coil end on the one end surface of the stator, and a second cover configured to cover the coil end on the other end surface of the stator. The link of the insulator is provided along an inner wall of the slot. The first cover and the second cover are provided with a supply port for a coolant to cool the stator coil and a discharge port for the coolant. The supply port is provided on a lower side in a direction of gravity, and the discharge port is provided on an upper side in the direction of gravity.

Another aspect of the disclosure provides a manufacturing method of a stator. The method comprises forming an insulator including a first protrusion provided on one end surface in an axial direction of a cylindrical stator core provided with slots, a second protrusion provided on the other end surface of the stator core, and a link provided along an inner wall of the slots and configured to link the first protrusion and the second protrusion; inserting segment coils into the slots of the stator core; twisting the segment coils along curved surfaces provided on the first protrusion and the second protrusion of the insulator to form a stator coil; securing the stator coil to the insulator; and securing a first cover to the first protrusion, the first cover configured to cover a coil end of the stator coil protruding from the stator core and the insulator on the one end surface of the stator core, and securing a second cover to the second protrusion, the second cover configured to cover a coil end of the stator coil protruding from the stator core and the insulator on the other end surface of the stator core.

### BRIEF DESCRIPTION OF THE DRAWINGS

FIG. 1 is a diagram illustrating a vehicle having a rotary electric machine.

FIG. 2 is a cross-sectional view of an exemplary configuration of the rotary electric machine according to a first embodiment.

FIG. 3 is a cross-sectional view of a stator core taken along line A-A of FIG. 2.

FIG. 4 is a cross-sectional view of a stator taken along line B-B of FIG. 2.

FIG. 5 is a cross-sectional view of the stator core having phase windings for a U-phase.

FIG. 6 is a perspective view of exemplary segment coils.

FIG. 7 is a perspective view of an exemplary stator.

FIG. 8 is diagram illustrating exemplary connection structures of the segment coils.

FIG. 9 is a cross-sectional view of the stator taken along line B-B of FIG. 2.

FIG. 10 is an exterior perspective view of a first protrusion of an insulator.

FIG. 11 is an exterior perspective view illustrating an enlarged portion of the first protrusion.

FIG. 12 is an exterior perspective view illustrating an enlarged portion of the first protrusion with segment coils attached.

FIG. 13 is a schematic cross-sectional view of a connector.

FIG. 14 is a diagram describing the attachment of the connector.

FIG. 15 is a flowchart describing a manufacturing process of the stator according to the first embodiment.

FIG. 16 is a schematic cross-sectional view of a stator according to a second embodiment.

FIG. 17 is a cross-sectional view of the stator taken along line C-C of FIG. 16.

FIG. 18 is a flowchart describing a manufacturing process of the stator according to the second embodiment.

FIG. 19 is a schematic cross-sectional view of a portion of the stator.

FIG. 20 is a schematic cross-sectional view of a portion of the stator.

FIG. 21 is a schematic cross-sectional view of a portion of the stator.

### DETAILED DESCRIPTION

Hereinafter, an embodiment of the disclosure will be described in detail with reference to drawings. In the following descriptions, the same or substantially same components and elements are denoted by the same reference signs and repetitive descriptions are omitted.

### First Embodiment

### Exemplary Usage of Rotary Electric Machine

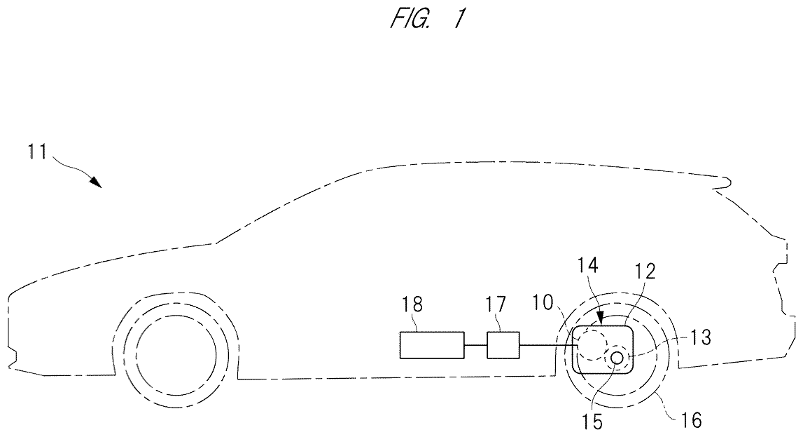

FIG. 1 is a diagram illustrating a vehicle 11 having a rotary electric machine 10. As illustrated in FIG. 1, the vehicle 11 is provided with an electric axle 14 including the rotary electric machine 10, a differential mechanism 13 and the like housed in an axle case 12. The rotary electric machine 10 and the differential mechanism 13 are coupled via a gear train (not illustrated), and wheels 16 are coupled to the differential mechanism 13 via an axle shaft 15.

Additionally, the rotary electric machine 10 serving as a motor generator is coupled to a battery 18 via an inverter 17 serving as a power converter. Note that the illustrated rotary electric machine 10 provided in the electric axle is merely an example and is not limited to this. The rotary electric machine may be provided in a transmission or another device, or may be provided in a non-vehicle device.

### Structure of Rotary Electric Machine 10

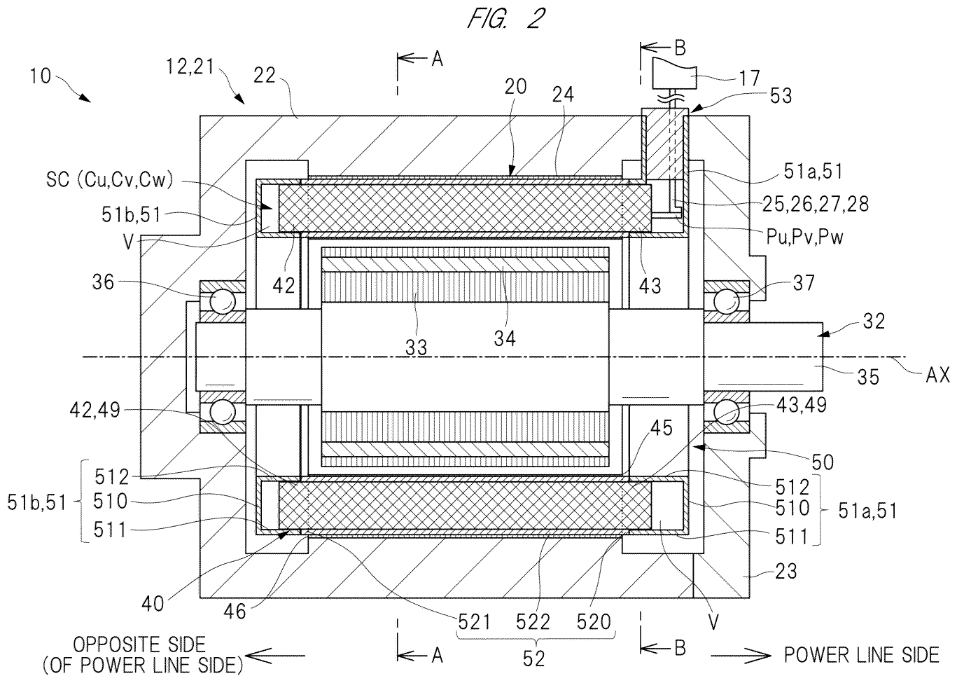

FIG. 2 is a cross-sectional view of an exemplary configuration of the rotary electric machine 10 according to a first embodiment. The rotary electric machine 10 illustrated in FIG. 2 is provided with a stator 20 and a cooling structure 50 according to an embodiment. As illustrated in FIG. 2, the rotary electric machine 10 has a motor case 21 that constitutes a part of the axle case 12. The motor case 21 has a cylindrical case body 22 with a bottom, and an end cover 23 that closes an open end of the case body 22. The stator 20 secured to the case body 22 is made of multiple laminated electromagnetic steel plates, and has a cylindrical stator core 24 centered on an axis AX, and three-phase stator coils SC wound around the stator core 24.

The stator coils SC are coupled to a busbar unit 25. This busbar unit 25 includes three power busbars (power lines) 26 to 28 coupled to three power points Pu, Pv, and Pw of the stator coils SC. Additionally, the power busbars 26 to 28 are coupled to the inverter 17 which is an external device via connectors 53 of the cooling structure 50 described in detail below.

Additionally, at the center of the stator core 24, a cylindrical rotor 32 is rotatably housed. This rotor 32 has a cylindrical rotor core 33 made of multiple laminated electromagnetic steel plates, permanent magnets 34 provided on the rotor core 33, and a rotor shaft 35 secured to the center of the rotor core 33. One end of the rotor shaft 35 is supported by a bearing 36 provided in the case body 22, and the other end of the rotor shaft 35 is supported by a bearing 37 provided in the end cover 23.

### Stator 20

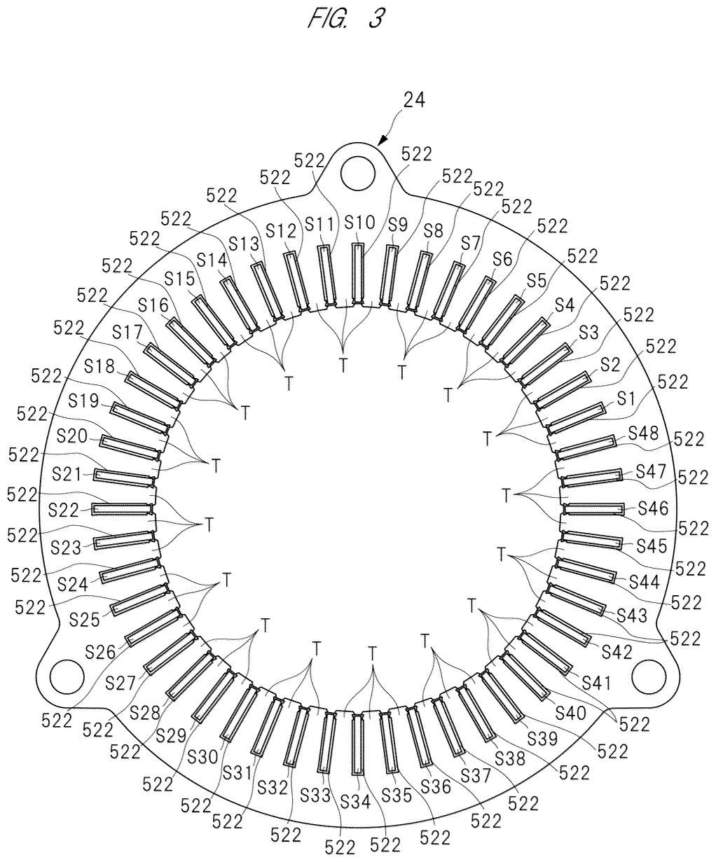

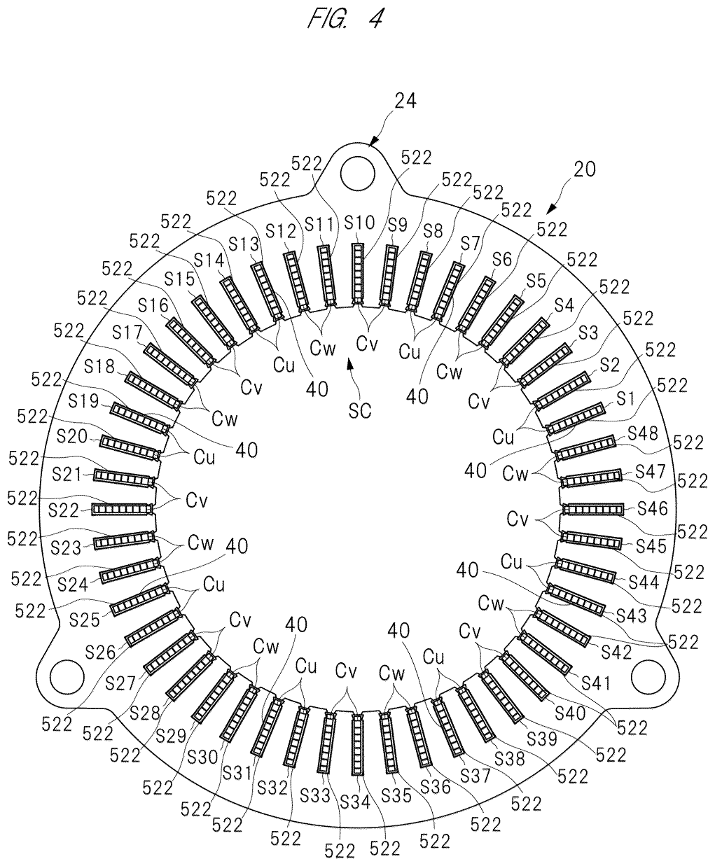

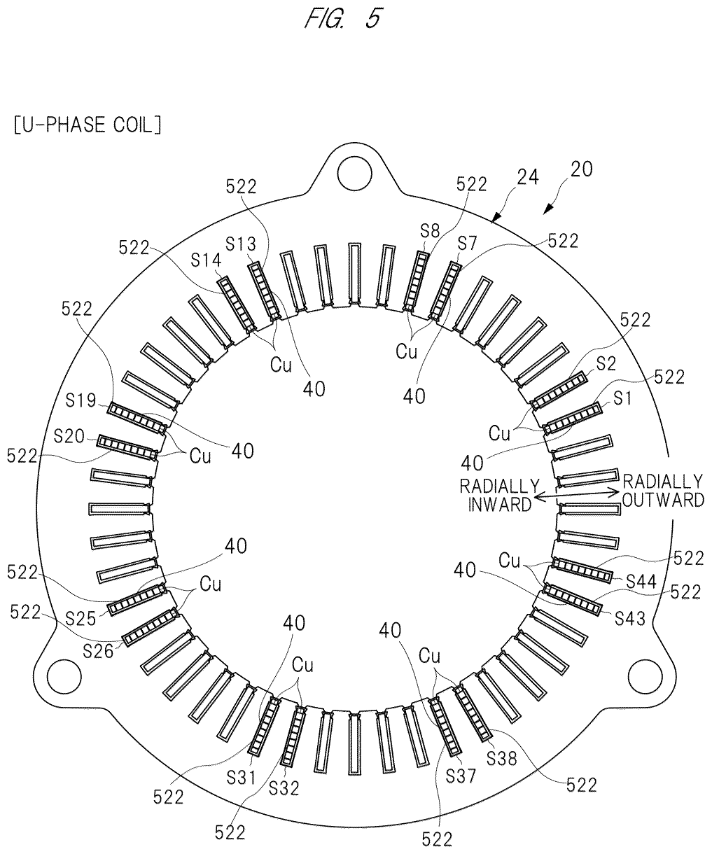

FIGS. 3 and 4 are cross-sectional views of a stator core taken along lines A-A and B-B of FIG. 2. FIG. 3 illustrates a state where the segment coils 40 are not housed in the stator core 24, and FIG. 4 illustrates a state where the segment coils 40 are housed in the stator core 24. Additionally, FIG. 5 is a cross-sectional view of the stator core 24 having phase windings for a U-phase (hereinafter referred to as U-phase coils Cu), and FIG. 6 is a perspective view of exemplary segment coils 40. As described below, the stator coil SC is composed of the U-phase coils Cu, phase windings for a V-phase (hereinafter referred to as V-phase coils Cv), and phase windings for a W-phase (hereinafter referred to as W-phase coils Cw). Additionally, the U-phase coils Cu, V-phase coils Cv, and W-phase coils Cw illustrating in the figures have the same coil structure and are mounted on the stator core 24 with their phases shifted by 120 degrees.

As illustrated in FIG. 3, teeth T are formed at predetermined intervals in a circumferential direction on an inner circumference of the stator core 24. That is, slots S1 to S48 are formed at predetermined intervals in the circumferential on the inner circumference of the stator core 24. As illustrated in FIG. 4, the segment coils 40 are housed in each of the slots S1 to S48, and the stator coil SC is formed by coupling the segment coils 40 to one another. As illustrated in FIGS. 4 and 5, the segment coils 40 constituting the U-phase coils Cu are housed in the slots S1, S2, S7, S8, and so on, the segment coils 40 constituting the V-phase coils Cv are housed in the slots S3, S4, S9, S10, and so on, and the segment coils 40 constituting the W-phase coils Cw are housed in the slots S5, S6, S11, S12, and so on.

Furthermore, as illustrated in FIG. 3, each of the slots S1 to S48 is provided with a link 522 formed in an insulator 52 of the cooling structure 50 described below.

As illustrated in FIG. 6, the segment coils 40 bent into a roughly U-shape have a pair of coil sides 41 spaced apart at a predetermined pitch. One of the coil sides 41 is housed in one of the slots (e.g., slot S7), and the other of the coil sides 41 is housed in another slot (e.g., slot S13) spaced apart at a predetermined pitch. Additionally, each of the segment coils 40 includes an end 42 that couples the pair of coil sides 41 to each other, and a joint end 43 that extends from each of the pair of coil sides 41. Note that each of the segment coils 40 is formed by a flat wire made of a conductive material such as copper, and an enamel or resin insulating coating is provided on the segment coils 40 except for the tips of the joint ends 43. Additionally, the shape of the end 42 constituting each of the segment coils 40 is not limited to the shape illustrated in the drawings, and may be bent into different shapes depending on the mounting position relative to the stator core 24.

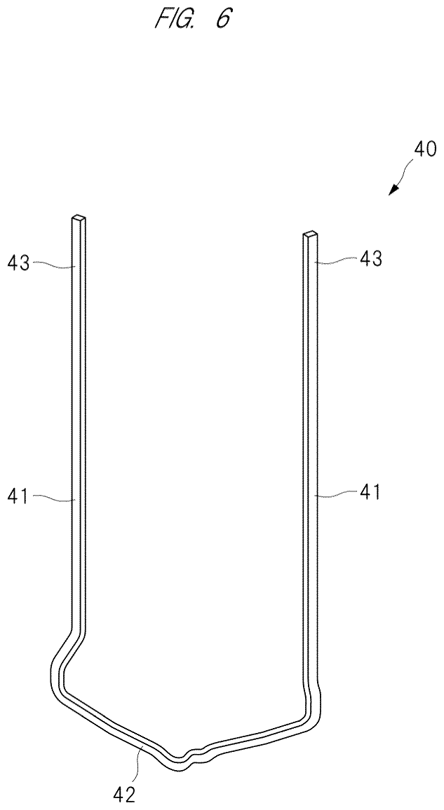

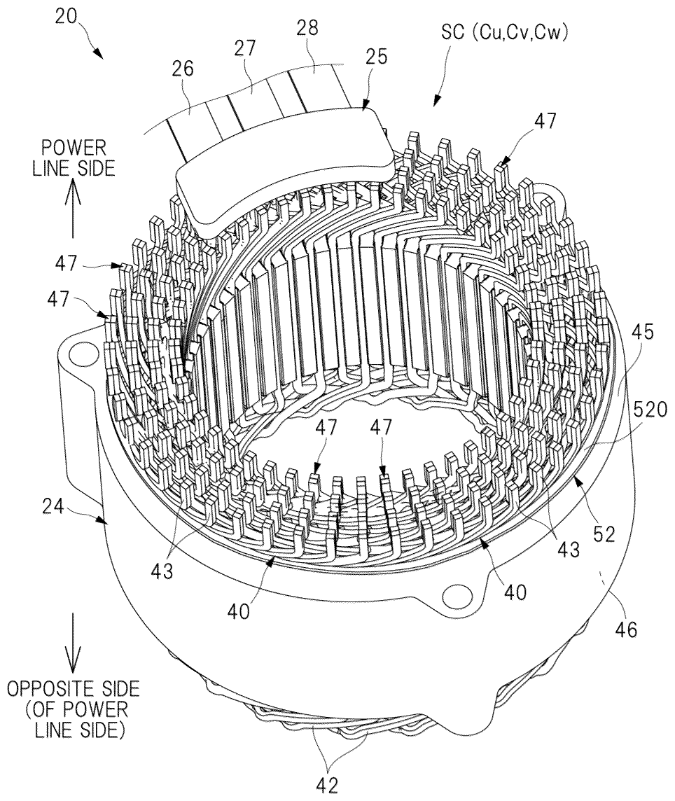

FIG. 7 is a perspective view of the exemplary stator 20, and FIG. 8 is a diagram illustrating exemplary connection structures of the segment coils 40. As illustrated in FIGS. 4 and 7, the segment coils 40 are mounted in each of the slots S1 to S48 of the stator core 24. Additionally, as illustrated in FIGS. 7 and 8, the joint ends 43 of the segment coils 40 are disposed protruding from one end surface 45 of the stator core 24 toward the power line side, and the ends 42 of the segment coils 40 are disposed protruding from the other end surface 46 of the stator core 24 toward the opposite side of the power line side.

As illustrated in FIG. 8, the joint ends 43 protruding from the one end surface 45 of the stator core 24 are bent to contact the joint ends 43 of the other segment coils 40, forming conductor joints 47. By welding each of the conductor joints 47 using TIG welding or the like, the segment coils 40 are coupled to one other via the conductor joints 47. That is, the U-phase coils Cu are formed by the segment coils 40, the V-phase coils Cv are formed by the segment coils 40, and the W-phase coils Cw are formed by the segment coils 40. Note that the conductor joints 47 that have been subjected to the welding processing are provided with an insulating treatment such as a resin coating to cover the conductors.

### Cooling Structure 50

The cooling structure 50 illustrated in FIG. 2 cools the joint ends 43 of the segment coils 40 protruding from the one end surface 45 of the stator core 24 and the ends 42 of the stator coils SC protruding from the other end surface 46. Specifically, the cooling structure 50 has a cover 51, the insulator 52, and a connector 53. The cover 51 is secured to the insulator 52, and the joint ends 43 and ends 42 of the stator coil SC are housed in a space V defined by the cover 51 and the insulator 52. Coolant such as ATF (automatic transmission fluid), is supplied into the space V, thereby cooling the stator coil SC. The structure of the cooling structure 50 will now be described in detail. Note that, in the following description, the joint ends 43 and the ends 42 of the stator coil SC may be collectively referred to as a coil end 49.

### Cover 51

The cover 51 includes a first cover 51a provided on a side of the one end surface 45 of the stator core 24, and a second cover 51b provided on a side of the other end surface 46 of the stator core 24.

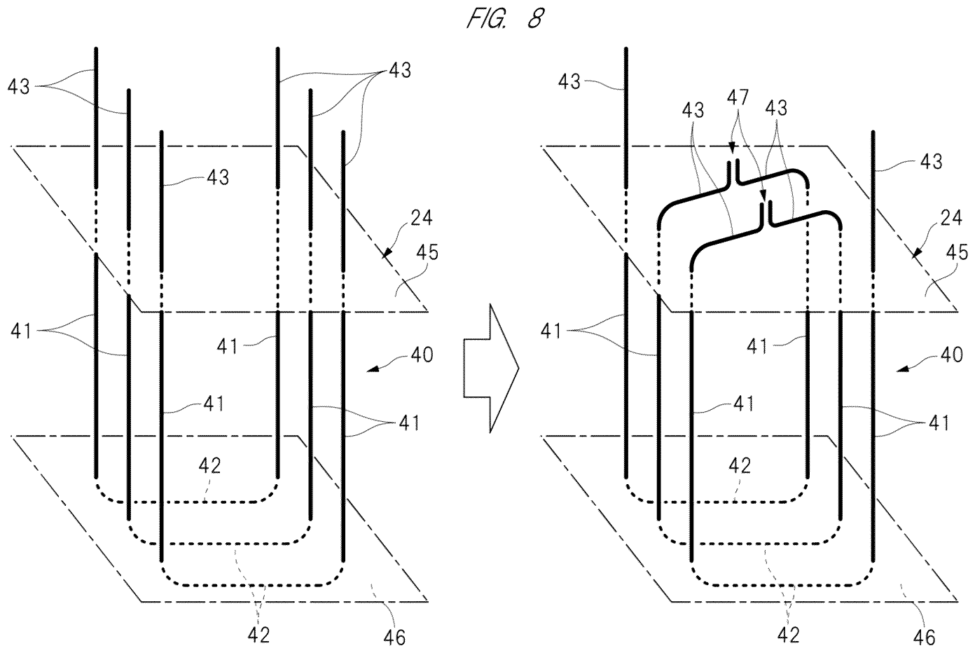

FIG. 9 is a cross-sectional view of the stator 20 taken along line B-B of FIG. 2. As illustrated in FIGS. 2 and 9, the first cover 51a has a first surface 510, a second surface 511, and a third surface 512. The first surface 510 (see FIG. 2) is an annular surface that intersects the axis AX of the stator core 24, or more specifically, is orthogonal to the axis. The second surface 511 is a wall surface coupled to an outer periphery of the first surface 510. The third surface 512 is a wall surface coupled to inner periphery of the first surface 510. The first cover 51a is made of thermoplastic resin, and the first surface 510, the second surface 511, and the third surface 512 are integrally formed.

The second surface 511 is provided with a supply port 513 and a discharge port 514. The supply port 513 is an opening through which coolant is supplied and is provided on a lower end side in the direction of gravity. A supply pipe (not illustrated) is coupled to the supply port 513. Such a supply pipe allows the supply port 513 to be coupled to a storage of the coolant via a pump such as an electric pump. The coolant stored in the storage is supplied to the supply port 513 by an operation of the pump.

The discharge port 514 is an opening through which coolant is discharged and is provided at a position above the segment coils 40 located at an uppermost end in the direction of gravity among the segment coils 40. In other words, as illustrated in FIG. 9, an open end 514a of the discharge port 514 is located above an uppermost end DX of the stator coil SC. A discharge pipe (not illustrated) is coupled to the discharge port 514. The other end of the discharge pipe is coupled to the above-described storage. Thus, the coolant discharged from the discharge port 514 is discharged into the storage.

Note that the second cover 51b has the same shape as the above-described first cover 51a. In other words, the second cover 51b also has the first surface 510, the second surface 511, and the third surface 512. In addition, the second surface 511 of the second cover 51b is provided with the supply port 513 at the lower end side in the direction of gravity, and the discharge port 514 is formed at a position in the upper direction of gravity.

The cover 51 having the above-described configuration is secured to the insulator 52 described below by, for example, high frequency welding.

### Insulator 52

The insulator 52 is an insulating member made of thermoplastic resin. The insulator 52 is formed by integrally molding a first protrusion 520, a second protrusion 521, and the link 522. The first protrusion 520 is provided on the side of the one end surface 45 along the axis AX of the stator core 24 and protrudes toward the power line side relative to the one end surface 45. The second protrusion 521 is provided on the side of the other end surface 46 along the axis AX of the stator core 24 and protrudes toward the opposite side of the power line side relative to the other end surface 46.

As illustrated in FIGS. 2, 4, and 5, the link 522 is provided along the inner walls of each of the slots S1 to S48 of the stator core 24 and links the first protrusion 520 and the second protrusion 521. Thus, each of the coil sides 41 of the segment coils 40 housed in the slots S1 to S48 is in contact with the inner peripheral wall of the link 522.

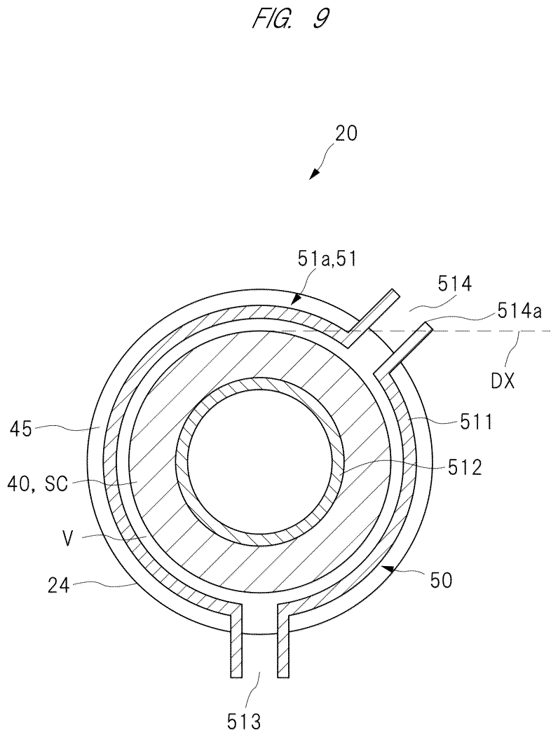

FIG. 10 is an exterior perspective view of the first protrusion 520, and FIG. 11 is an exterior perspective view illustrating an enlarged portion of the first protrusion 520. As the first protrusion 520 and the second protrusion 521 have the same shape, the following description also applies to the second protrusion 521.

The first protrusion 520 has an outer peripheral protrusion 60, an inner peripheral protrusion 61, and radial protrusions 62. The outer peripheral protrusion 60 is an annular protrusion centered on the axis AX. An inner diameter of the outer peripheral protrusion 60 is equal to or approximately equal to an outer diameter of the slots S1 to S48 of the stator core 24. The inner peripheral protrusion 61 is an annular protrusion centered on the axis AX. An outer diameter of the inner peripheral protrusion 61 is smaller than the inner diameter of the outer peripheral protrusion 60, and an inner diameter of the inner peripheral protrusion 61 is larger than the inner diameter of the stator core 24. Thus, the outer peripheral protrusion 60 is located radially outward relative to the stator coil SC, and the inner peripheral protrusion 61 is located radially inward relative to the stator coil SC.

The above-described first cover 51a is secured to the first protrusion 520 by high frequency welding. Specifically, the end of the second surface 511 of the first cover 51a is secured to the outer peripheral protrusion 60, and the end of the third surface 512 of the first cover 51a is secured to the inner peripheral protrusion 61. Similarly, the second cover 51b is secured to the second protrusion 521 by high frequency welding. Thus, the coil end 49 of the stator coil SC protruding from the stator core 24 is housed in the space V defined by the cover 51 and the insulator 52. In other words, the cover 51 is secured to the insulator 52 and covers the coil end 49.

As illustrated in FIGS. 10 and 11, the radial protrusions 62 is formed along a radial direction of the first protrusion 520 and is linked to the outer peripheral protrusion 60 and the inner peripheral protrusion 61. Specifically, each of the radial protrusions 62 is provided at an upper portion of each of the teeth T formed at predetermined intervals in the circumferential direction of the stator core 24. That is, the first protrusion 520 has openings 63 formed at positions corresponding to the positions of the slots S1 to S48 formed at predetermined intervals in the circumferential direction. The segment coils 40 protrude outward through these openings 63. The inner wall surface of each of the openings 63 is linked to the link 522 at the end on the side of the one end surface 45 of the stator core 24.

The protrusion amount (height) of each of the radial protrusions 62 from the one end surface 45 of the stator core 24 is greater than the protrusion amounts (heights) of the outer peripheral protrusion 60 and the inner peripheral protrusion 61. Furthermore, the end of each of the radial protrusions 62 is formed with a curved surface 620 extending along the radial direction. The curved surface 620 is curved in accordance with the bending shape of the segment coils 40.

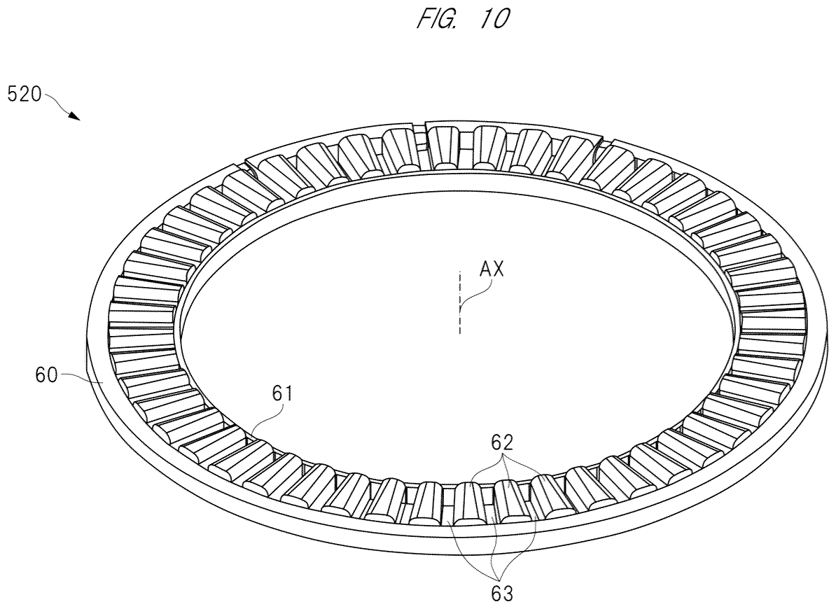

FIG. 12 is an exterior perspective view illustrating an enlarged portion of the first protrusion 520 with the segment coils 40 attached to the stator core 24. As illustrated in FIG. 12, a curvature radius of the curved surface 620 is the same or approximately the same as the bending radius of the segment coils 40 bent to contact the joint end 43 of other segment coils 40. In other words, during the twisting process of bending the segment coils 40, the curved surface 620 serves as a guide for the bending shape of the segment coils 40.

Additionally, as illustrated in FIG. 11, a curved surface 621 is formed on a portion of the outer peripheral protrusion 60. The curved surface 621 is formed on the side of the inner peripheral surface of the outer peripheral protrusion 60. The curvature radius of the curved surface 621 is the same or approximately the same as the bending radius of the segment coil 40a bent toward the side of the outer periphery of the stator core 24 illustrated in FIG. 12. Thus, during the bending process of the segment coil 40a, the curved surface 621 serves as a guide for the bending shape of the segment coil 40a. Note that the segment coils 40a are coupled to the power busbars 26 to 28 described above.

### Connector 53

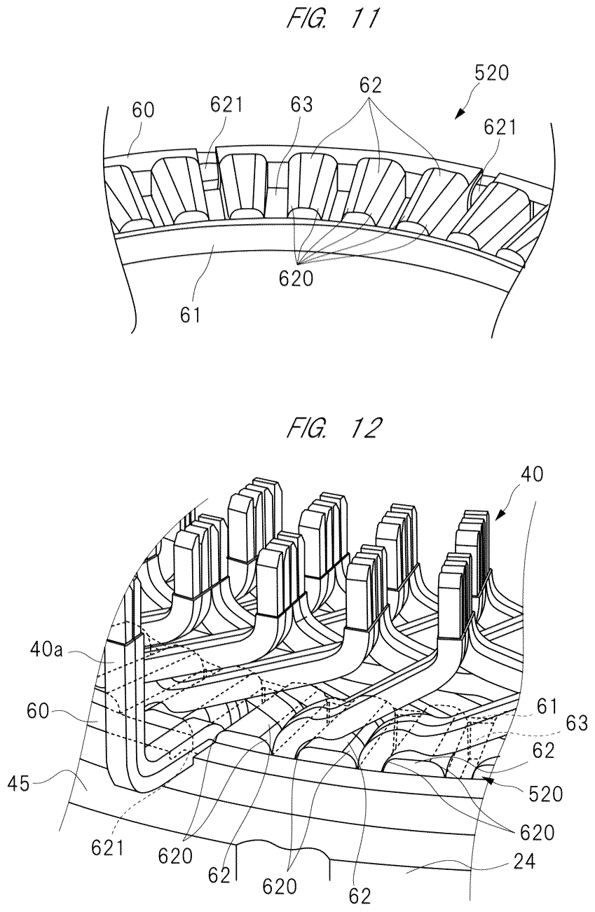

FIG. 13 is a schematic cross-sectional view of the connector 53. The connector 53 has a mating portion 530 and a base 531. The base 531 is cylindrical and is disposed on a terminal block 533 provided with terminals for electrically connecting to an external device such as the inverter 17. The base 531 is inserted into a mounting opening 515 formed in the first cover 51a. An inner diameter of the mounting opening 515 is the same or approximately the same as an outer diameter of the base 531.

A portion of the outer peripheral wall of the base 531 has a groove 531a formed along the outer periphery. A sealing member 534 such as an O-ring is provided in the groove 531a. In other words, the base 531 mates with the mounting opening 515 of the first cover 51a via the sealing member 534. Thus, the base 531 and the first cover 51a are in close contact, and the coolant in the first cover 51a is suppressed from leaking out between the base 531 and the mounting opening 515.

The mating portion 530 is a cylindrical connector provided on the base 531. The mating portion 530 mates with the ends of the power busbars 26 to 28 in the space V. Note that the ends of the power busbars 26 to 28 are cylindrical. Additionally, a mating portion 530 is provided for each of the power busbars 26 to 28.

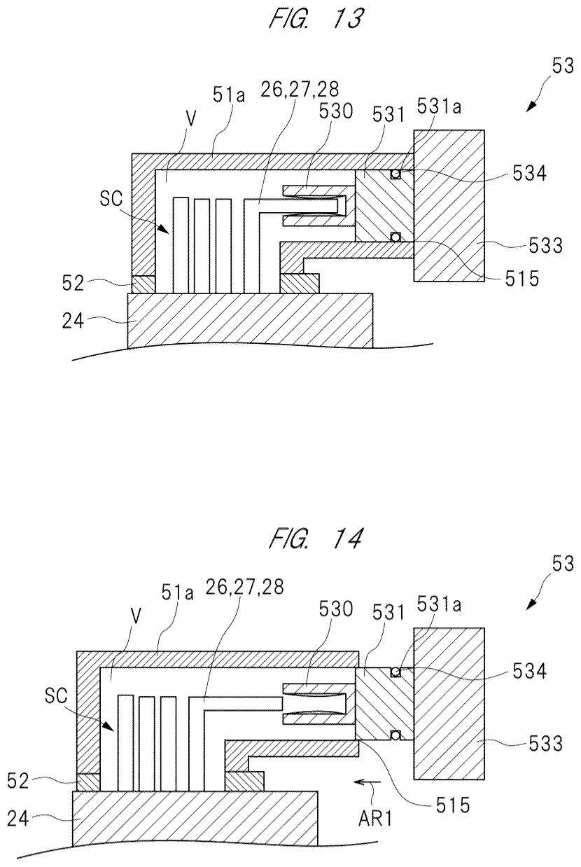

FIG. 14 is a cross-sectional view similar to FIG. 13 and describing an attachment process of the connector 53. The base 531 is inserted into the mounting opening 515 of the first cover 51a. Then, when the connector 53 is moved in the direction of the arrow AR1, the ends of the power busbars 26 to 28 are inserted into the cylindrical mating portion 530. The first cover 51a and the base 531 are joined by thermal bonding or the like.

### Manufacturing Method of Stator 20

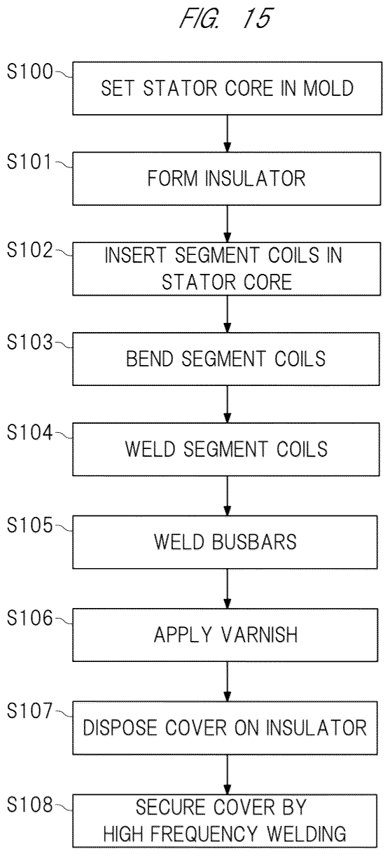

Next, a manufacturing method of the stator 20 according to the first embodiment will be described with reference to FIG. 15. FIG. 15 is a flowchart describing the manufacturing process of the stator 20.

In step S100, the stator core 24 formed by laminating core plates is set into a mold corresponding to an outer shape of the above-described insulator 52. In step S101, the insulator 52 having the aforementioned shape is formed onto the one end surface 45 and the other end surface 46 of the stator core 24 and the inner peripheral walls of the slots S1 to S48. In such a case, the insulator 52 is formed by injection molding or low-pressure molding using thermoplastic resin in the mold.

In step S102, the segment coils 40 are inserted into the opening 63 of the insulator 52 and the slots S1 to S48 of the stator core 24. In such a case, for example, the stator core 24 is mounted on a press machine, and the joint ends 43 of the segment coils 40 are inserted into the slots S1 to S48 of the stator core 24. Then, as the press machine descends, the segment coils 40 are pressed. As a result, the coil sides 41 of the segment coils 40 are inserted into the slots S1 to S48 of the stator core 24.

In step S103, the joint ends 43 of the segment coils 40 protruding from the one end surface 45 of the stator core 24 are bent to form the conductor joints 47 by the joint ends 43 of the segment coils 40. At this time, as described above, the curved surface 620 formed on each of the radial protrusions 62 of the insulator 52 serves as a guide for bending the segment coils 40.

In step S104, the segment coils 40 are joined by welding the conductor joints 47 using TIG welding or the like to complete the stator coil SC. In step S105, the power busbars 26 to 28 are welded. In step S106, a varnish made of resin or an organic solvent is infiltrated into a gap between the insulator 52 formed on the stator core 24 and the stator coil SC, and then is cured. This tightly secures the stator coil SC to the stator core 24.

In step S107, a cover 51 is disposed on the insulator 52. At this time, the end of the second surface 511 of the cover 51 is disposed on the first protrusion 520, and the end of the third surface 5 12 of the cover 51 is disposed on the second protrusion 521. In step S108, the cover 51 is secure to the insulator 52. In such a case, a horn of a high-frequency welding machine is pressed against the end of the second surface 511 and the end of the third surface 512 of the cover 51. As a result, the cover 51 is welded and secured to the insulator 52. Through the above steps, the stator 20 comprising the cooling structure 50 is manufactured.

When the above-described stator 20 is installed in the vehicle 11, the coolant is supplied via the supply port 513 formed in the cover 51 by a pump or the like (not illustrated). In other words, the coolant is supplied from the lower end side in the direction of gravity into the space V between the cover 51 and the insulator 52. The coolant supplied into the space V is discharged to the outside through the discharge port 514. As described above, the open end 514a of the discharge port 514 is provided above the uppermost end DX of the stator coil SC. Thus, the coolant reaches all of the segment coils 40 in the space V, and the occurrence of thermal distribution where the stator 20 becomes locally overheated is suppressed. Additionally, since heat transfer to areas other than the stator 20 is prevented, heat recovery efficiency is improved.

Additionally, the link 522 of the insulator 52 is provided along the inner walls of each of the slots S1 to S48 of the stator core 24. In other words, the coil sides 41 of the segment coils 40 and the link 522 are in close contact with each other, and the coolant is not supplied to the interior of the slots S1 to S48. Thus, there is no need to increase the pressure of the coolant compared to when the coolant enters the interior of the slots S1 to S48.

According to the first embodiment described above, one or more of the following effects is achieved.
(1) The cooling structure 50 comprises the cover 51 and the insulator 52. The insulator 52 has the first protrusion 520 provided on one end surface 45 of one side along the axis AX of the stator core 24, the second protrusion 521 provided on the other end surface 46 of the other side, and a connecting portion 522 provided along the inner walls of slots S1 to S48, and the link 522 that links the first protrusion 520 and the second protrusion 521. The cover 51 is secure to the insulator 52 and covers the coil end 49. The supply port 513 for the coolant is provided on the lower side of the cover 51 in the direction of gravity, and the discharge port 514 is provided on the upper side of the cover 51 in the direction of gravity.

The coolant is supplied into the space V partitioned by the cover 51 and the insulator 52. Thus, compared to a method where the coolant is sprayed from above the stator 20 to cool the coil end 49, there is no need to provide a pipe or another structure at the upper part of the stator 20. As a result, the number of components and the space required for pipes or other structures can be reduced.

Additionally, the coolant is supplied from the lower part of the space V and discharged from the upper part. In particular, the open end 514a of the discharge port 514 is provided above the uppermost end DX of the stator coil SC. Thus, the coolant supplied into the space V reaches all of the segment coils 40. As a result, the occurrence of thermal distribution where the stator 20 becomes locally overheated is suppressed. Additionally, since heat transfer to components other than the stator 20 is prevented, heat recovery efficiency is improved.

Additionally, the link 522 of the insulator 52 is provided along the inner walls of each of the slots S1 to S48 of the stator core 24. Since the coil sides 41 of the segment coils 40 are in close contact with the link 522, the coolant is not supplied into the interior of the slots S1 to S48. Thus, compared to supplying the coolant to the interior of slots S1 to S48, the need to increase the pressure when supplying coolant is suppressed. In other words, even if the discharge pressure of the pump for supplying the coolant is reduced compared to supplying the coolant to the interior of slots S1 to S48, the occurrence of heat distribution can be suppressed.

Additionally, the cover 51 is made of synthetic resin. This prevents grounding between the conductor joints 47 of the segment coils 40 and the motor case 21. Additionally, the cover 51 made of the synthetic resin and the insulator 52 have a high clamping force. Thus, reliability of the strength for securing the insulator 52 to the cover 51 is improved, and leakage of the coolant from the cover 51 and the insulator 52 caused by vibration and the like is suppressed.
(2) The first protrusion 520 and the second protrusion 521 of the insulator 52 are provided with the outer peripheral protrusion 60, the inner peripheral protrusion 61, and the radial protrusions 62. Each of the radial protrusions 62 is provided with the curved surface 620 corresponding to the bending shape of the segment coils 40. Thus, during the manufacturing of the stator 20, the segmented coils 40 can be bent using the curved surface 620 as a guide, making it possible to eliminate the need for a twisting die for the segmented coils 40 and to reduce the amount of equipment.
(3) The connector 53 has the mating portion 530 that mates with the ends of the power busbars 26 to 28 in the space V defined by the insulator 52 and the first cover 51a, and the base 531 on which the mating portion 530 is provided. The base 531 mates with the mounting opening 515 formed in the first cover 51a via the sealing member 534. This allows the power busbars 26 to 28 provided at the ends of the segment coils 40 and the power line of the external device such as the inverter 17 to be easily coupled in the space V. Additionally, in a case of a structure having the power busbars 26 to 28 and the power line of the external device coupled outside the space V, additional components such as sealing materials or covers for the power busbars 26 to 28 to prevent coolant leakage are required at the positions where the power busbars 26 to 28 are extended from the first cover 51a. In contrast, in the present embodiment, it is possible to couple the power busbars 26 to 28 to the power line of the external device without requiring additional components to prevent coolant leakage.

### Second Embodiment

Hereinafter, the stator of a second embodiment will be described with reference to the drawings. In the following description, the same reference signs are used for the same or substantially the same components as those of the stator 20 according to the first embodiment, and repeated descriptions are omitted.

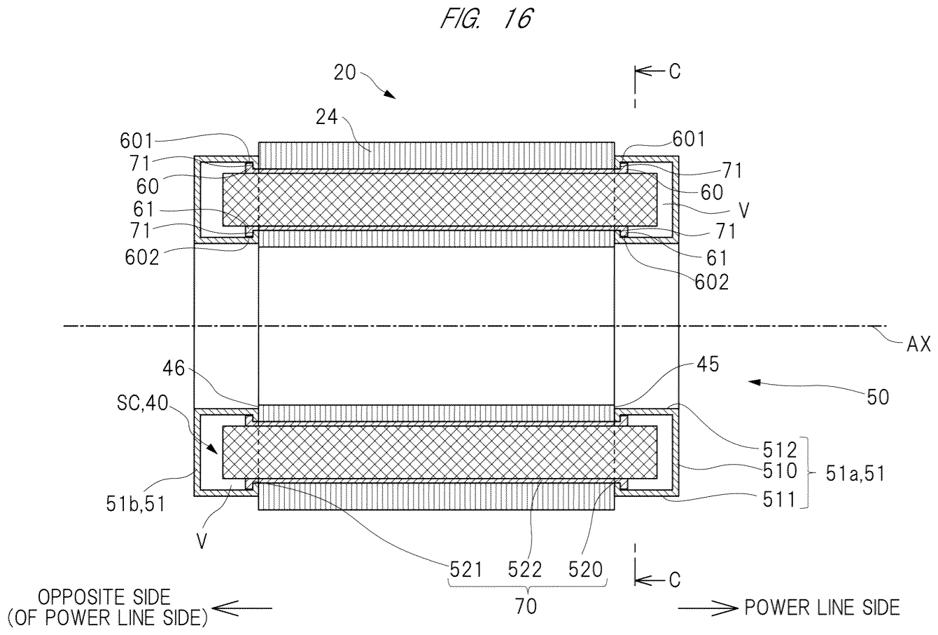

FIG. 16 is a schematic cross-sectional view of the stator 20 according to the second embodiment. FIG. 17 is a cross-sectional view of the stator 20 taken along line C-C of FIG. 16. The stator 20 according to the second embodiment has the cover 51 similar to that of the first embodiment and an insulator 70 different from that of the first embodiment.

The insulator 70 is formed by integrally molding the first protrusion 520, the second protrusion 521, and the link 522 similar to those of the first embodiment. The outer diameters of the outer peripheral protrusions 60 of the first protrusion 520 and the second protrusion 521 are smaller than the inner diameter of the second surface 511 of the cover 51. Additionally, the inner diameter of the inner peripheral protrusion 61 of the first protrusion 520 and the second protrusion 521 is larger than the outer diameter of the third surface 512 of the cover 51.

The insulator 70 is made of thermosetting resin such as crystalline epoxy resin. The thermosetting resin has high narrow-part filling properties, so when forming the link 522, no draft angle is required for each of the slots S1 to S48. Thus, the area (occupancy rate) occupied by the segment coil 40 for each of the slots S1 to S48 can be increased.

The thermosetting resin insulator 70 and the thermoplastic resin cover 51 are secured by thermal caulking. Thermal caulking is performed in the directions indicated by the arrows at positions P1 to P17 illustrated in FIG. 17. In other words, thermal caulking is performed at nine locations including positions P1 to P9 in the circumferential direction of the second surface 511 of the cover 51. Similarly, thermal caulking is performed at eight locations including positions P10 to P17 in the circumferential direction of the third surface 512 of the cover 51. Note that the locations and number of thermal caulking points are not limited to the example illustrated in FIG. 17.

The insulator 70 has notches 71 formed at positions corresponding to the positions P1 to P17 where the thermal caulking described above is performed. Specifically, nine notches 71 are formed along the circumferential direction on an outer peripheral surface 601 of the outer peripheral protrusion 60 of each of the first protrusions 520 and the second protrusion 521, and eight notches 71 are formed along the circumferential direction on an inner peripheral surface 602 of the inner peripheral protrusion 61.

### Manufacturing Method of Stator 20

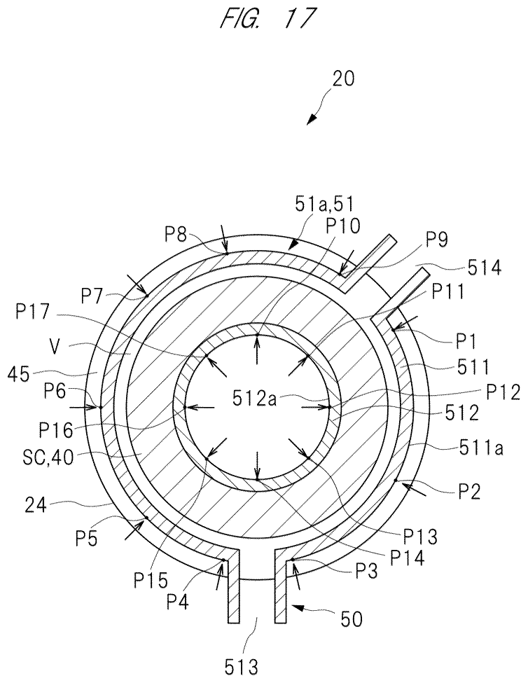

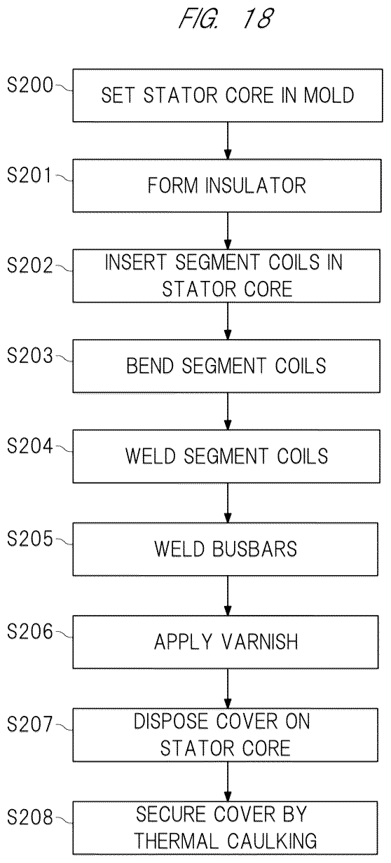

Next, the manufacturing method of the stator 20 of the second embodiment will be described with reference to FIG. 18. FIG. 18 is a flowchart describing the manufacturing process of the stator 20. Each step S200 to S206 in FIG. 18 is the same as each step S100 to S106 in the flowchart shown in FIG. 15.

In step S207, a sealing member is provided along an outer periphery of the insulator 70 formed on the stator core 24, and then the cover 51 is disposed on the stator core 24. FIGS. 19 to 21 are schematic cross-sectional views of a portion of the stator 20 at position P1. As described above, the outer diameter of the outer peripheral protrusions 60 of each of the first protrusion 520 and the second protrusion 521 is smaller than the inner diameter of the second surface 511 of the cover 51. Thus, the second surface 511 of the cover 51 disposed on the stator core 24 is located radially outward from the outer peripheral protrusion 60.

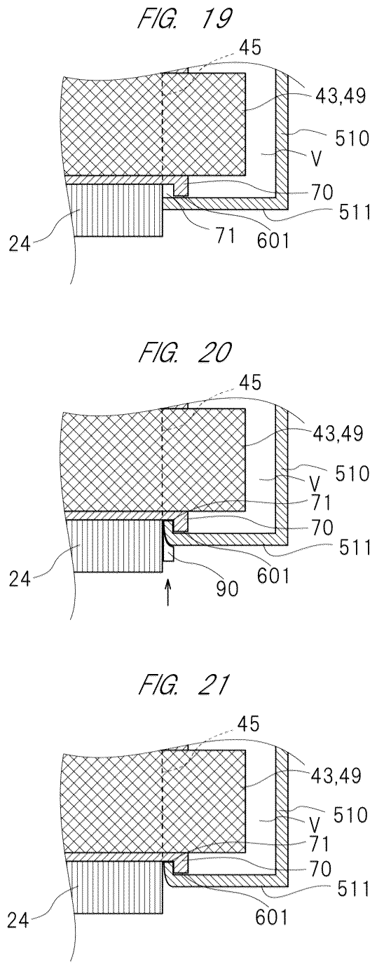

In step S208, the cover 51 is secured by thermal caulking. As illustrated in FIG. 20, a tool 90 such as a horn is pressed against the cover 51 in the radial direction along the direction of the arrow. As a result, a portion of the cover 51 enters the notches 71 formed in the insulator 70. Then, the tool 90 is pulled in the opposite direction of the arrow such that the cover 51 and the insulator 70 are secured by thermal caulking as illustrated in FIG. 21. The thermal caulking is performed at all positions P1 to P17 using the above method.

According to the above-described second embodiment, the following effects are obtained in addition to the effects (1) to (3) obtained by the first embodiment.
(4) The outer peripheral protrusion 60 and the inner peripheral protrusion 61 of the first protrusion 520 and the second protrusion 521 of the thermosetting resin insulator 70 are provided with the notches 71 along the circumferential direction. The cover 51 is secured to the insulator 70 by thermal caulking at the notches 71. This allows the thermoplastic resin cover 51 to be secured to the thermosetting resin insulator 70.

Additionally, the thermosetting resin insulator 70 has high narrow-part filling properties, so when forming the link 522, no draft angle is required for each of the slots S1 to S48. Thus, the occupancy rate of the segment coil 40 relative to the stator core 24 can be increased, thereby contributing to improved efficiency of the rotary electric machine 10.

This disclosure is not limited to the above embodiments and may be modified in various ways within the range not departing from the gist of the disclosure. In the above description, the segment coils 40 are connected in series to form each phase coil Cu, Cv, and Cw, but the disclosure is not limited to this, and the segment coils 40 may be connected in parallel to form each phase coil Cu, Cv, and Cw. Additionally, in the illustrated example, eight segment coils 40 are inserted into each slot, but the disclosure is not limited to this, and more than eight segment coils 40 may be inserted into each slot, or fewer than eight segment coils 40 may be inserted into each slot. Additionally, in the preceding description, the stator core 24 having 48 slots is used, but the disclosure is not limited to this, and the stator core with any other number of slots may be used.

According to the disclosure, it is possible to cool the segment coils in a state where occurrence of temperature distribution is suppressed.

1. A coil end cooling structure configured to cool a stator including a cylindrical stator core and a stator coil provided in a slot of the stator core and having a coil end protruding from an end surface in an axial direction of the stator core, the coil end cooling structure comprising:
an insulator including a first protrusion provided on one end surface of the stator core in the axial direction, a second protrusion provided on the other end surface, and a link configured to link the first protrusion and the second protrusion; and
a first cover secured to the insulator and configured to cover the coil end on the one end surface of the stator, and a second cover configured to cover the coil end on the other end surface of the stator,
wherein the link of the insulator is provided along an inner wall of the slot,
wherein the first cover and the second cover are provided with a supply port for a coolant to cool the stator coil and a discharge port for the coolant, and
wherein the supply port is provided on a lower side in a direction of gravity, and the discharge port is provided on an upper side in the direction of gravity.

2. The coil end cooling structure according to claim 1,
wherein the first protrusion and the second protrusion of the insulator are each provided with an annular outer peripheral protrusion and an annular inner peripheral protrusion, and a radial protrusion linked to the outer peripheral protrusion and the inner peripheral protrusion, and
wherein the radial protrusion is provided with a curved surface corresponding to a bending shape of each segment coil of the stator coil.

3. The coil end cooling structure according to claim 2, further comprising
a connector configured to couple a power line provided on the stator core to an external device,
wherein the connector includes:
a mating portion configured to mate with an end of the power line in a space defined by the insulator and the first cover; and
a base on which the mating portion is provided,
wherein the base is configured to mate with a mounting opening formed in the first cover via a sealing member.

4. The coil end cooling structure according to claim 3,
wherein the insulator is made of thermosetting resin,
wherein the outer peripheral protrusion and the inner peripheral protrusion of each of the first protrusion and the second protrusion of the insulator are each provided with a notch along a circumferential direction, and
wherein the first cover and the second cover are secured to the insulator by thermal caulking at the notch.

5. A manufacturing method of a stator, comprising:
forming an insulator including a first protrusion provided on one end surface in an axial direction of a cylindrical stator core provided with slots, a second protrusion provided on the other end surface of the stator core, and a link provided along an inner wall of the slots and configured to link the first protrusion and the second protrusion;
inserting segment coils into the slots of the stator core;
twisting the segment coils along curved surfaces provided on the first protrusion and the second protrusion of the insulator to form a stator coil;
securing the stator coil to the insulator; and
securing a first cover to the first protrusion, the first cover configured to cover a coil end of the stator coil protruding from the stator core and the insulator on the one end surface of the stator core, and securing a second cover to the second protrusion, the second cover configured to cover a coil end of the stator coil protruding from the stator core and the insulator on the other end surface of the stator core.
